(19) United States
(12) Patent Application Publication
(10) Pub. No.: US 2025/0003290 A1
(43) Pub. Date: Jan. 2, 2025

(54) ROOF LADDER ANCHOR APPARATUS

(71) Applicant: Hahn Roofing and Restoration, LLC, Marietta, GA (US)

(72) Inventor: Christopher Dillon Hahn, Marietta, GA (US)

(73) Assignee: Hahn Roofing and Restoration, LLC, Marietta, GA (US)

(21) Appl. No.: 18/345,565

(22) Filed: Jun. 30, 2023

(51) Int. Cl. E06C 7/46; E06C 7/14

(52) U.S. Cl. CPC E06C 7/46; E06C 7/14

(57) ABSTRACT

A roof ladder anchor apparatus including a base plate and a U-shaped ladder ridge hook is disclosed. The base plate may include a base plate top surface and a base plate bottom surface. The base plate bottom surface may include a non-slip grip material. The U-shaped ladder ridge hook may be attached to the base plate top surface and may be configured to secure a ladder bottom portion when a ladder may be placed on the apparatus. The apparatus may further include a first handle and a second handle that may be attached to the base plate top surface. The first handle and the second handle may be disposed in proximity to base plate opposite edges.

### TECHNICAL FIELD

The present disclosure relates to a roof ladder anchor apparatus, and more specifically to a roof ladder anchor apparatus that enables a user to stably secure a ladder on a slanted surface.

### BACKGROUND

Users often use ladders to access heights that may be inaccessible to them. For example, a user may use a ladder to climb a rooftop for repair or to perform a paint job on a wall. The user may rest or lean the ladder against the wall or a roof top edge, and then climb the ladder to access heights that may be inaccessible to the user due to user height constraints.

There are known instances of ladders slipping from their bottom surfaces when the users climb on them. A ladder slip may cause injury to the user, and is hence undesirable. Probability of ladder slip may considerably increase when the surface on which the ladder bottom surface rests may be wet or slanted at an angle. For example, the probability of ladder slip may considerably increase when the user rests the ladder on a slanted roof surface, e.g., to access a second level roof or a roof top edge.

Thus, there is a need for an apparatus that may facilitate the user to safely use the ladder on a slanted or wet surface.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A depicts a ladder secured in an example roof ladder anchor apparatus that is placed on a slanted roof in accordance with the present disclosure.

FIG. 1B depicts a ladder secured in the roof ladder anchor apparatus of FIG. 1A that is placed on a flat surface in accordance with the present disclosure.

FIG. 2 depicts a top isometric view of an example roof ladder anchor apparatus in accordance with the present disclosure.

FIG. 3 depicts a bottom isometric view of the roof ladder anchor apparatus of FIG. 2 in accordance with the present disclosure.

FIG. 4 depicts a top isometric view of another example roof ladder anchor apparatus in accordance with the present disclosure.

FIG. 5 depicts a top isometric view of yet another example roof ladder anchor apparatus in accordance with the present disclosure.

### DETAILED DESCRIPTION

### Overview

The present disclosure is directed towards a roof ladder anchor apparatus that may facilitate a user to conveniently and safely use a ladder on an inclined or a wet surface. The apparatus may be placed on the surface and the user may place a ladder bottom end in the apparatus to secure the ladder. An apparatus bottom surface may include a non-slip grip material that may securely affix the apparatus to the surface, thereby enabling the user to climb the ladder placed in the apparatus and access heights inaccessible to the user.

The apparatus may include a base plate having a base plate top surface and a base plate bottom surface. The base plate bottom surface may include the non-slip grip material that may be, e.g., foam, rubber, or a combination thereof. The apparatus may further include a U-shaped ladder ridge hook that may be permanently or removably attached to the base plate top surface. The U-shaped ladder ridge hook may include a pair of gussets and a ladder leg stop portion disposed between the pair of gussets. When the user places the ladder bottom end in the apparatus, the ladder bottom end may rest against the ladder leg stop portion, which ensures that the ladder may not slip from the apparatus.

In some aspects, the apparatus may further include one or more handles attached to the base plate top surface that may facilitate the user to conveniently pick and transport the apparatus. The apparatus may additionally include one or more flexible clips disposed on the base plate top surface that may facilitate the user store tools or equipment on the apparatus.

In further aspects, one or more of the U-shaped ladder ridge hook and the handles may be pivotally attached to the base plate top surface. The user may fold or “collapse” the U-shaped ladder ridge hook and the handles on the base plate top surface when the apparatus may not be in use and/or when the user desires to store the apparatus.

The present disclosure discloses a roof ladder anchor apparatus that facilitates the user in using the ladder on inclined or wet surfaces. Since the apparatus bottom surface includes the non-slip grip material, the apparatus (and hence the ladder) does not slip on inclined or wet surfaces. Further, the apparatus includes handles that make the apparatus portable, thus enhancing apparatus usability.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

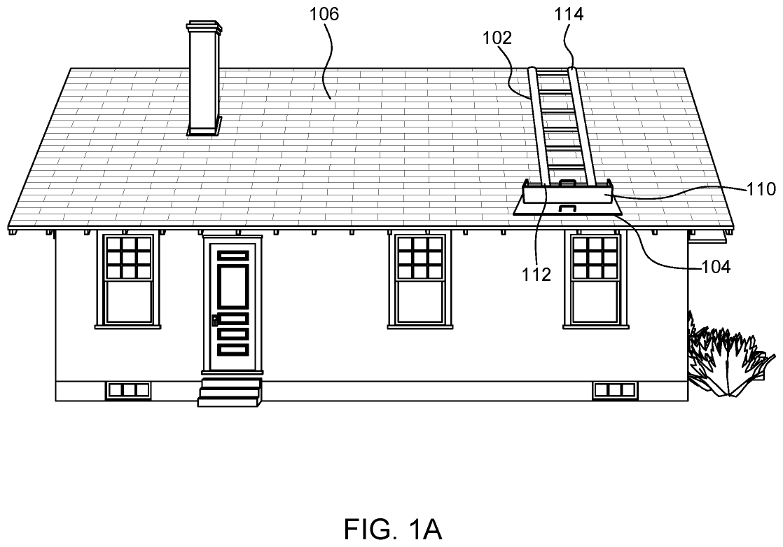

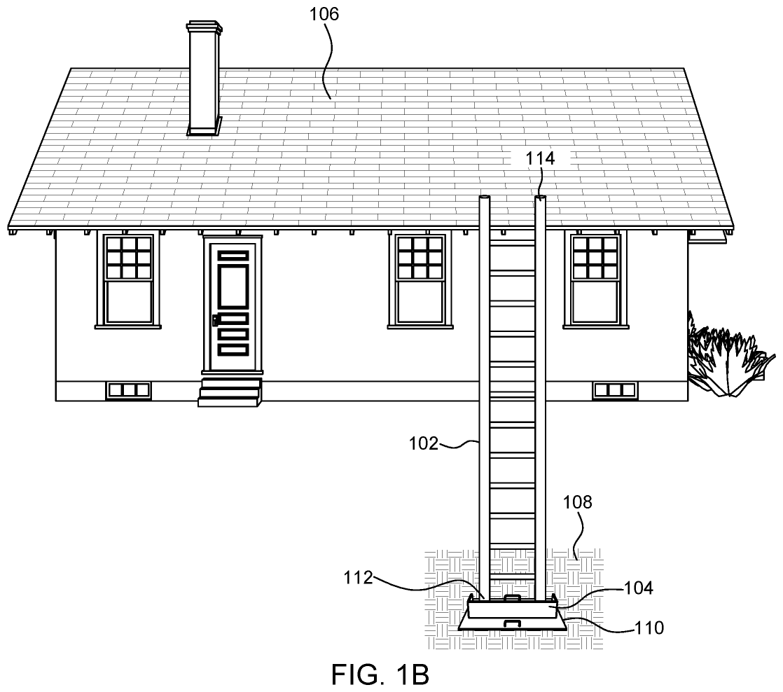

FIG. 1A depicts a ladder 102 secured in an example roof ladder anchor apparatus 104 that is placed on a slanted roof 106 in accordance with the present disclosure. FIG. 1A will be described in conjunction with FIG. 1B, which depicts the ladder 102 secured in the roof ladder anchor apparatus 104 that is placed on a flat surface 108.

The ladder 102 may be a conventional ladder including, but not limited to, a straight ladder, an extension ladder, a telescoping ladder, etc. Further, the ladder 102 may be of wood, fiberglass, metal such as aluminum, steel, and/or the like. The ladder 102 may be of any height and/or width, based on ladder usage requirements.

The roof ladder anchor apparatus 104 (or apparatus 104) may be configured to be securely placed on a surface, e.g., the slanted roof 106 (as shown in FIG. 1A), or the flat surface 108, e.g., a concrete surface (as shown in FIG. 1B). In some aspects, an apparatus bottom surface may include a non-slip grip material (e.g., foam, rubber, a combination thereof, etc.) that may ensure that the apparatus 104 does not slip when the apparatus 104 is placed on the slanted roof 106 or the flat surface 108. The non-slip grip material may further ensure that the apparatus 104 does not slip even if the slanted roof 106 or the flat surface 108 is wet or has presence of algae.

The apparatus 104 may include a U-shaped bracket or a U-shaped ladder ridge hook 110 (or ridge hook 110) that may be configured to securely house a ladder bottom end 112. For example, a user (not shown) may place the apparatus 104 on the slanted roof 106 or the flat surface 108, and then place or plant the ladder bottom end 112 in the ridge hook 110. Further, when the user places the apparatus 104 on the slanted roof 106, the user may place a ladder top end 114 in proximity to a roof top end (as shown in FIG. 1A) and use the ladder 102 to climb to the roof top end. Since the apparatus bottom surface includes the non-slip grip material, the apparatus 104 (and hence the ladder 102) may not slip when the user climbs the ladder 102. In this manner, the apparatus 104 facilitates the user in safely using the ladder 102 on slanted or inclined surfaces.

In a similar manner, when the user places the apparatus 104 on the flat surface 108, the user may further place the ladder top end 114 in proximity to a roof bottom end or rest against the wall, and use the ladder 102 to climb to the roof 106 (as shown in FIG. 1B). In this usage embodiment as well, the apparatus 104 (and hence the ladder 102) may not slip when the user climbs the ladder 102, even if the flat surface 108 is wet or has presence of algae.

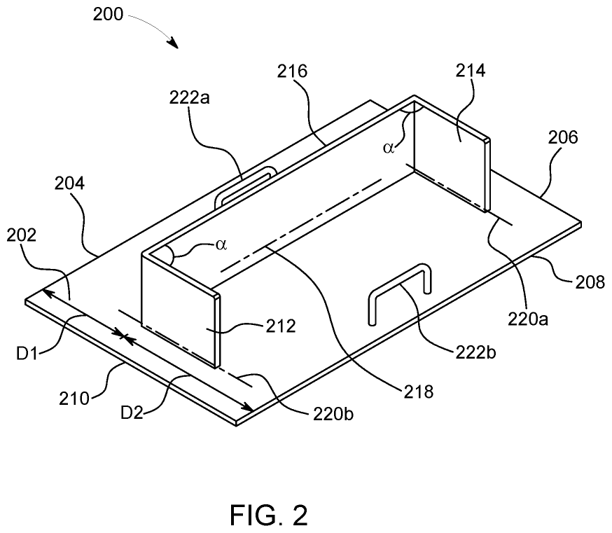

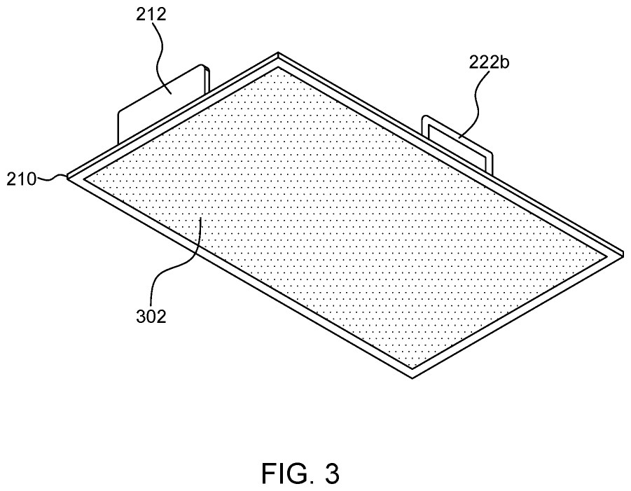

Apparatus structural details are described below in conjunction with FIGS. 2 and 3.

FIG. 2 depicts a top isometric view of an example roof ladder anchor apparatus 200 in accordance with the present disclosure. While describing FIG. 2, references may be made to FIG. 3, which depicts a bottom isometric view of the roof ladder anchor apparatus 200.

The roof ladder anchor apparatus 200 (or apparatus 200) may be same as the apparatus 104 described above in conjunction with FIG. 1. The apparatus 200 may include a base plate having a base plate top surface 202 and a base plate bottom surface 302 (as shown in FIG. 3). The base plate may be made of metal such as steel, iron, aluminum, and/or the like, and may be of any shape. For example, the base plate may be shaped as an oval, a square, a rectangle, etc. In the exemplary aspect depicted in FIGS. 2 and 3, the base plate may be rectangular having a first edge 204, a second edge 206, a third edge 208 and a fourth edge 210.

As depicted in FIG. 2, the first edge 204 and the third edge 208 may be parallel to each other, and each of the first edge 204 and the third edge 208 may be perpendicular to the second edge 206 and the fourth edge 210. Further, the second edge 206 and the fourth edge 210 may be parallel to each other. Furthermore, first and third edge dimensions may be equivalent to each other and second and fourth edge dimensions may be equivalent to each other. The dimensions of each base plate edge may depend on apparatus usage and/or dimensions of a ladder (e.g., the ladder 102) that may be required to be placed in the apparatus 200.

The base plate bottom surface 302 may include a non-slip grip material, e.g., foam, rubber, a combination thereof, etc., which may be removably attached to the base plate bottom surface 302 via adhesive, fastening means (not shown) or Velcro™. The non-slip grip material may ensure that the base plate bottom surface 302 securely adheres to a surface on which the base plate bottom surface 302 may be placed (e.g., the slanted roof 106 or the flat surface 108) and does not slip. Further, the non-slip grip material may ensure that as more weight is applied on the non-slip grip material, the non-slip grip material may more tightly “grip” or adhere to the slanted roof 106 or the flat surface 108, and prevent base plate bottom surface slippage.

The apparatus 200 may further include U-shaped ladder ridge hook (or ridge hook) attached to the base plate top surface 202. The ridge hook may include a first gusset 212, a second gusset 214 and a ladder leg stop portion 216. The ridge hook may be made of same material as the base plate and may be configured to secure the ladder bottom end 112 when the ladder 102 may be placed in the apparatus 200 (as shown in FIGS. 1A and 1B).

In some aspects, each of the first gusset 212, the second gusset 214 and the ladder leg stop portion 216 may be metal plates that may be welded on the base plate top surface 202 via respective bottom edges. In other aspects, one or more of the first gusset 212, the second gusset 214 and the ladder leg stop portion 216 may be removably attached to the base plate top surface 202 via respective bottom edges by using fastening means (not shown). Stated another way, the ridge hook may be permanently affixed to the base plate top surface 202 by welding, or may be removably affixed or attached to the base plate top surface 202 by using fastening means.

The ladder leg stop portion 216 may be disposed between the first gusset 212 and the second gusset 214. Further, a longitudinal axis 218 of the ladder leg stop portion 216 may be disposed at a predefined angle “a” relative to longitudinal axis 220a, 220b of each of the first gusset 212 and the second gusset 214. In some aspects, the angle “a” may be in a range of 60 to 90 degrees. In the exemplary aspect depicted in FIG. 2, the angle “a” is 90 degrees. Stated another way, in the aspect depicted in FIG. 2, the ladder leg stop portion 216 is disposed perpendicularly between the first gusset 212 and the second gusset 214.

A ladder leg stop portion length may be greater than lengths of each of the first gusset 212 and the second gusset 214. Further, the first gusset 212 and the second gusset 214 may have equivalent lengths. In some aspects, the ladder leg stop portion length and first and second gusset lengths may depend on base plate dimensions. Furthermore, heights of the ladder leg stop portion 216, the first gusset 212 and the second gusset 214 (measured from the base plate top surface 202) may be equivalent to each other and may depend on apparatus usage requirements.

In some aspects, lateral axis of each of the ladder leg stop portion 216, the first gusset 212 and the second gusset 214 may be perpendicular to the base plate. Stated another way, the metal plates of each of the ladder leg stop portion 216, the first gusset 212 and the second gusset 214 may be perpendicularly attached to the base plate top surface 202. Further, the longitudinal axis 218 may be parallel to the first edge 204 and the third edge 208. In an exemplary aspect, the ladder leg stop portion length may be lesser than respective first and third edge lengths. For example, the ladder leg stop portion length may be in a range of 40-80% of the lengths of each of the first edge 204 and the third edge 208. Furthermore, a distance “D1” between the ladder leg stop portion 216 and one edge (e.g., the first edge 204) may be lesser than a distance “D2” between the ladder leg stop portion 216 and the third edge 208.

A person ordinarily skilled in the art may appreciate that such an arrangement of the ladder leg stop portion 216 relative to the first edge 204 and the third edge 208 may enable secure ladder housing in the ridge hook. Specifically, when the user places the ladder bottom end 112 in the ridge hook and the apparatus 2300 is placed on the slanted roof 106, a substantial part of a ladder portion in proximity to the ladder bottom end 112 may touch the base plate top surface 202 between the ladder leg stop portion 216 and the third edge 208, thereby providing stable and substantial “contact area” between the ladder 102 and the base plate top surface 202. Substantial contact area between the ladder 102 and the base plate top surface 202 ensures that the ladder 102 does not topple when the ladder 102 is placed in the apparatus 200 on the slanted roof 106.

In further aspects, the longitudinal axis 220a, 220b may be parallel to the second edge 206 and the fourth edge 210. In addition, first and second gusset lengths may be lesser than respective second and fourth edge lengths. For example, the lengths of each of the first gusset 212 and the second gusset 214 may be in a range of 30-60% of the lengths of each of the second edge 206 and the fourth edge 210. Furthermore, in some aspects, a distance between the first gusset 212 and the fourth edge 210 may be equivalent to a distance between the second gusset 214 and the second edge 206. In other aspects, the distance between the first gusset 212 and the fourth edge 210 may be different from the distance between the second gusset 214 and the second edge 206.

In operation, the user may place the apparatus 200 on the slanted roof 106 or the flat surface 108, and then house the ladder bottom end 112 in the ridge hook. The ladder bottom end 112 may rest against the ladder leg stop portion 216 to secure the ladder 102 in the ridge hook, and then the user may use the ladder 102 to climb to the roof 106 or the roof top edge. The anti-slip grip surface at the base plate bottom surface 302 ensures that the apparatus 200 does not slip, and hence provides a stable and secure base for the ladder 102 in the apparatus 200.

In additional aspects, the apparatus 200 may include one or more handles to enable the user to conveniently lift and transport the apparatus 200. For example, in the exemplary aspect depicted in FIG. 2, the apparatus 200 may include a first handle 222a and a second handle 222b disposed on the base plate top surface 202. The first handle 222a and the second handle may be disposed in proximity to base plate opposite edges, to enable the user to conveniently lift the apparatus 200. For example, the first handle 222a may be disposed in proximity to the first edge 204 and the second handle 222b may be disposed in proximity to the third edge 208. In other aspects (not shown), the first handle 222a may be disposed in proximity to the second edge 206 and the second handle 222b may be disposed in proximity to the fourth edge 210.

The first handle 222a and the second handle 222b may be made of same material as the base plate, and may have same shape and dimensions. In the exemplary aspect depicted in FIG. 2, the first handle 222a and the second handle 222b may be U-shaped handles that may be welded to the base plate top surface 202. In other aspects, the first handle 222a and the second handle 222b may be removably attached to the base plate top surface 202 by using fastening means (not shown).

In some aspects, when the ridge hook and the first and second handles 222a, 222b are removably attached to the base plate top surface 202, the user may remove these units from the base plate when the apparatus 200 may not be in use or when the user desires to transport the apparatus 200. In this manner, apparatus usability may be enhanced, thereby enhancing user convenience.

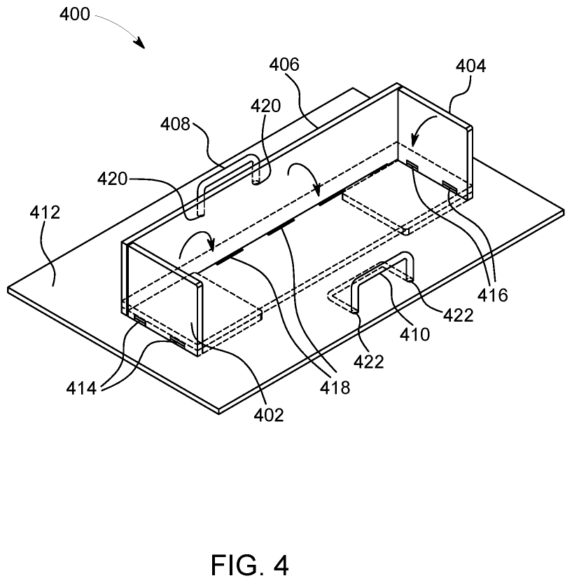

FIG. 4 depicts a top isometric view of another example roof ladder anchor apparatus 400 in accordance with the present disclosure. The roof ladder anchor apparatus 400 (or apparatus 400) may be similar to the apparatus 200; however, instead of having the ridge hook and the first and second handles 222a, 222b rigidly attached to the base plate, these units may be pivotally attached to the base plate via respective hinges in the apparatus 400.

The apparatus 400 may include a first gusset 402, a second gusset 404, a ladder leg stop portion 406, a first handle 408 and a second handle 410. The first and second gussets 402, 404 may be same as the first and second gussets 212, 214, the ladder leg stop portion 406 may be same as the ladder leg stop portion 216, and the first and second handles 408, 410 may be same as the first and second handles 222a, 222b. Further, relative arrangement of these units on the base plate of the apparatus 400 may be same as the relative arrangement of respective units on the base plate of the apparatus 200.

The apparatus 400 may further include a base plate top surface 412 (which may be same as the base plate top surface 202), and a first hinge 414 that may pivotally attach the first gusset 402 to the base plate top surface 412. Similarly, the apparatus 400 may include a second hinge 416 that may pivotally attach the second gusset 404 to the base plate top surface 412 and a third hinge 418 that may pivotally attach the ladder leg stop portion 406 to the base plate top surface 412.

In some aspects, the ridge hook may be foldable via the first hinge 414, the second hinge 416 and the third hinge 418. Stated another way, the first gusset 402, the second gusset 404 and the ladder leg stop portion 406 may be collapsible (as shown in FIG. 4) so that these units may lay flat on the base plate top surface 412. Specifically, respective lateral axis of these units may be disposed parallel to the base plate top surface 412 when the units may be in fully “collapsed” state.

A person ordinarily skilled in the art may appreciate that by making the ridge hook foldable or collapsible, apparatus usability may be enhanced. For example, the user may collapse the ridge hook when the apparatus 400 may not be in use or when the user desires to transport the apparatus 400, thereby enhancing user convenience. In additional aspects, the apparatus 400 may include a fourth hinge 420 that may pivotally attach the first handle 408 to the base plate top surface 412 and a fifth hinge 422 that may pivotally attach the second handle 410 to the base plate top surface 412. The first and second handles 408, 410 may be foldable/collapsible via the fourth and fifth hinges 420, 422 respectively, to enable the user to conveniently store the apparatus 400 (e.g., when the apparatus 400 may not be in use or transported).

Remaining elements/units of the apparatus 400 are same as respective elements/units of the apparatus 200, and hence are not described again here for the sake of simplicity and conciseness.

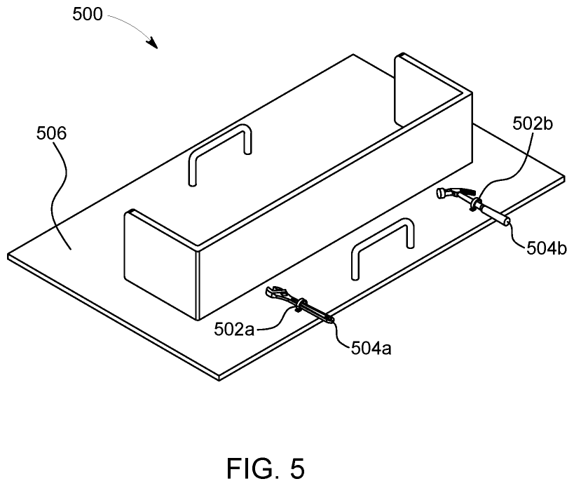

FIG. 5 depicts a top isometric view of another example roof ladder anchor apparatus 500 in accordance with the present disclosure. The roof ladder anchor apparatus 500 (or apparatus 500) may be same as the apparatus 200; however, the apparatus 500 may additionally include one or more clips 502a, 502b that may be configured to securely hold one or more tools or equipment 504a, 504b. The clips 502a, 502b may be disposed on a base plate top surface 506 (which may be same as the base plate top surface 202) and may be made of flexible material such as plastic, rubber, etc.

While using the ladder 102 and the apparatus 500 on the slanted roof 106, the user may use the clips 502a, 502b to hold the tools 504a, 504b (that may be used for repair work on the slanted roof 106). The user may also hold additional tools or equipment in the U-shaped ladder ridge hook.

Although FIG. 5 depicts two clips, the apparatus 500 may include more or less than two clips. Further, the clips 502a, 502b may be disposed anywhere on the base plate top surface 506. Example clip arrangement as depicted in FIG. 5 should not be construed as limiting the present disclosure scope.

Remaining elements/units of the apparatus 500 are same as respective elements/units of the apparatus 200, and hence are not described again here for the sake of simplicity and conciseness.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. An apparatus comprising:
a base plate having a base plate top surface and a base plate bottom surface, wherein the base plate bottom surface comprises a non-slip grip material;
a U-shaped ladder ridge hook attached to the base plate top surface, wherein the U-shaped ladder ridge hook is configured is secure a ladder bottom portion when a ladder is placed on the apparatus, and wherein the U-shaped ladder ridge hook comprises a first gusset, a second gusset and a ladder leg stop portion disposed perpendicularly between the first gusset and the second gusset; and
a first handle and a second handle attached on the base plate top surface, wherein the first handle and the second handle are disposed in proximity to base plate opposite edges.

2. The apparatus of claim 1, wherein a ladder leg stop portion length is greater than length of each of the first gusset and the second gusset.

3. The apparatus of claim 1, wherein a lateral axis of each of the first gusset, the second gusset and the ladder leg stop portion is perpendicular to the base plate.

4. The apparatus of claim 1, wherein the base plate comprises a first edge, a second edge, a third edge and a fourth edge, wherein the first edge and the third edge are parallel to each other, and wherein the first edge and the third edge are perpendicular to the second edge and the fourth edge.

5. The apparatus of claim 4, wherein the first handle is disposed in proximity to the first edge, and wherein the second handle is disposed in proximity to the third edge.

6. The apparatus of claim 4, wherein a ladder leg stop portion longitudinal axis is parallel to the first edge and the third edge, and wherein a longitudinal axis of each of the first gusset and the second gusset is parallel to the second edge and the fourth edge.

7. The apparatus of claim 1, wherein the U-shaped ladder ridge hook is removably attached to the base plate top surface.

8. The apparatus of claim 1, wherein the first handle and the second handle are removably attached to the base plate top surface.

9. The apparatus of claim 1 further comprising:
a first hinge configured to pivotally attach the first gusset to the base plate top surface;
a second hinge configured to pivotally attach the second gusset to the base plate top surface; and
a third hinge configured to pivotally attach the ladder leg stop portion to the base plate top surface,
wherein the U-shaped ladder ridge hook is foldable via the first hinge, the second hinge and the third hinge.

10. The apparatus of claim 1 further comprising a fourth hinge configured to pivotally attach the first handle on the base plate top surface and a fifth hinge configured to pivotally attach the second handle on the base plate top surface.

11. The apparatus of claim 1 further comprising a clip disposed on the base plate top surface, wherein the clip is configured to secure a tool or an equipment.

12. An apparatus comprising:
a base plate having a base plate top surface and a base plate bottom surface, wherein the base plate bottom surface comprises a non-slip grip material;
a U-shaped ladder ridge hook attached to the base plate top surface, wherein the U-shaped ladder ridge hook is configured is secure a ladder bottom portion when a ladder is placed on the apparatus, and wherein the U-shaped ladder ridge hook comprises a first gusset, a second gusset and a ladder leg stop portion disposed perpendicularly between the first gusset and the second gusset;
a first hinge configured to pivotally attach the first gusset to the base plate top surface;
a second hinge configured to pivotally attach the second gusset to the base plate top surface; and
a third hinge configured to pivotally attach the ladder leg stop portion to the base plate top surface,
wherein the U-shaped ladder ridge hook is foldable via the first hinge, the second hinge and the third hinge.

13. The apparatus of claim 12 further comprising a first handle and a second handle attached on the base plate top surface, wherein the first handle and the second handle are disposed in proximity to base plate opposite edges.

14. The apparatus of claim 13, wherein the base plate comprises a first edge, a second edge, a third edge and a fourth edge, wherein the first edge and the third edge are parallel to each other, and wherein the first edge and the third edge are perpendicular to the second edge and the fourth edge.

15. The apparatus of claim 14, wherein the first handle is disposed in proximity to the first edge, and wherein the second handle is disposed in proximity to the third edge.

16. The apparatus of claim 14, wherein a ladder leg stop portion longitudinal axis is parallel to the first edge and the third edge, and wherein a longitudinal axis of each of the first gusset and the second gusset is parallel to the second edge and the fourth edge.

17. The apparatus of claim 12, wherein a ladder leg stop portion length is greater than length of each of the first gusset and the second gusset.

18. The apparatus of claim 12, wherein a lateral axis of each of the first gusset, the second gusset and the ladder leg stop portion is perpendicular to the base plate.

19. The apparatus of claim 12, wherein the U-shaped ladder ridge hook is removably attached to the base plate top surface.

20. An apparatus comprising:
a base plate having a base plate top surface and a base plate bottom surface, wherein the base plate bottom surface comprises a non-slip grip material; and
a U-shaped ladder ridge hook removably attached to the base plate top surface, wherein:
the U-shaped ladder ridge hook is configured is secure a ladder bottom portion when a ladder is placed on the apparatus,
the U-shaped ladder ridge hook comprises a first gusset, a second gusset and a ladder leg stop portion disposed perpendicularly between the first gusset and the second gusset, and
a ladder leg stop portion length is greater than length of each of the first gusset and the second gusset.
